(19) United States
(12) Patent Application Publication
(10) Pub. No.: US 2010/0269656 A1
(43) Pub. Date: Oct. 28, 2010

(54) TABLE SAW WITH SYMMETRICAL RAIL FENCE STORAGE CAPABILITY

(75) Inventor: Andrew Frolov, Glenview, IL (US)

Correspondence Address: GREER, BURNS & CRAIN, 300 S WACKER DR, 25TH FLOOR, CHICAGO, IL, 60606, US

(73) Assignees: CREDO TECHNOLOGY CORPORATION, Broadview, IL (US); ROBERT BOSCH GMBH, Stuttgart (DE)

(21) Appl. No.: 12/431,044

(22) Filed: Apr. 28, 2009

(51) Int. Cl. B26D 7/06

(52) U.S. Cl. 83/438

(57) ABSTRACT

Embodiments are disclosed for a power table saw that comprises a base, a table top with a opening through which a rotating blade can extend, the table top assembly extending outwardly beyond the base assembly on at least one side thereof, front and rear rails extending across the width of the table top, a fence having a clamping handle configured to be selectively moved between clamping and releasing positions, thereby enabling the fence to be adjustably mounted to the front and rear rails for selectively positioning the same at different operating locations relative to the blade, the fence being removable from the front and rear rails when the clamping handle is released, the front and rear rails being configured to retain the fence in the operating locations and to also clamp the fence in a stored location wherein the fence is underneath the table top surface.

### BACKGROUND OF THE INVENTION

The present invention generally relates to power table saws, and particularly portable power table saws.

Artisans that use portable table saws often bring their table saws on site to make cuts that are necessary as a part of their construction work. Many of the cuts that are made require the use of a rip fence that is almost universally supplied with such portable table saws. In prior commercial products, the rip fence, when not in use, has been stored on the base or lower saw frame below the table top assembly which is locked into place by the user. Because the storage capability is often an afterthought, the structure for storing the rip fence when not in use often only comprises plastic clips or the like which are not particularly easy to use or have a long useful life given the kind of treatment and exposure to damage conditions that exist on a construction site.

### SUMMARY OF THE INVENTION

Embodiments are disclosed for a power table saw assembly that comprises a base assembly configured to retain a motor assembly for driving a rotatable blade, a table top assembly having a top surface with a opening through which a rotating blade can extend, front and rear edge portions generally perpendicular to the top surface, the table top assembly extending outwardly beyond the base assembly on at least one side thereof, a front rail extending across and operatively connected to the front edge of the table top assembly, a rear rail extending across and operatively connected to the rear edge of the table top assembly, a fence having a clamping handle configured to be selectively moved between clamping and releasing positions, thereby enabling the fence to be adjustably mounted to the front and rear rails for selectively positioning the same at different operating locations relative to the blade, the fence being removable from the front and rear rails when the clamping handle is released, the front and rear rails being configured to retain the fence in the operating locations and to also clamp the fence in a stored location wherein the fence is underneath the table top surface.

Another embodiment of the present invention has front and rear rails respectively mounted to the front and rear faces of the table top assembly, wherein both rails have the same identical rail cross sectional configuration to accommodate both front and rear ends of the fence. This embodiment merely requires that the front and rear rails be rotated 180° relative to one another. Storing the fence under the table top requires reversing the ends of the fence, i.e., the end having the clamping handle would be attached to the rear rail.

### DESCRIPTION OF THE DRAWINGS

FIG. 1 is a perspective view from an upper right front perspective of a power table saw assembly having a rip fence attached to the table saw in operating position in accordance with an embodiment of the present invention;

FIG. 2 is a front plan view of the table saw shown in FIG. 1, and illustrating the fence embodying the present invention shown in a stored fence position;

FIG. 3 is a right side view of a preferred embodiment of the present invention shown in FIG. 1, with the fence being shown in the stored position as in FIG. 2;

FIG. 4 is an enlarged version of the table saw shown in FIGS. 1-3, with portions removed and enlarged to show details of the present invention;

FIG. 5 is a side view of a portion of the embodiment shown in FIGS. 1-4, and particularly illustrating the front and rear rails of the embodiment;

FIG. 6 is a side view, partially in section and with portions removed, illustrating a rip fence installed and locked on a table saw in an upright operating position; and

FIG. 7 is a view similar to FIG. 5, illustrating an alternative embodiment of the front and rear rails.

### DETAILED DESCRIPTION

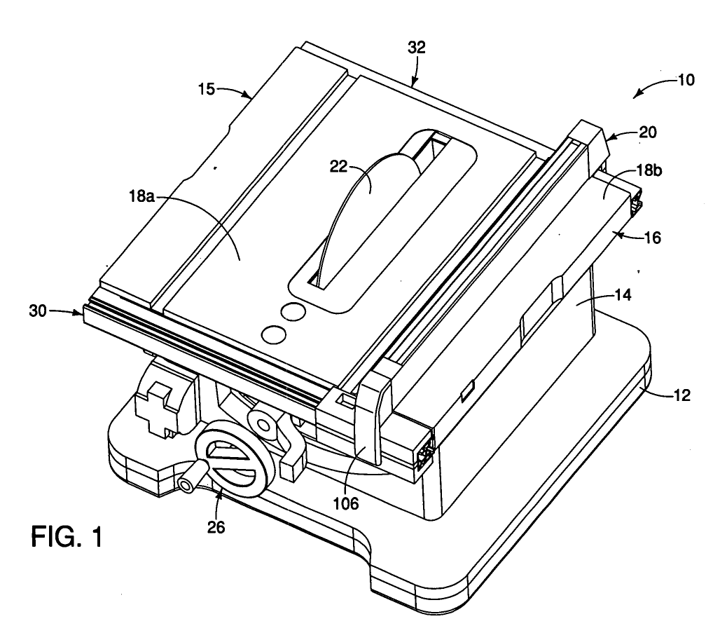

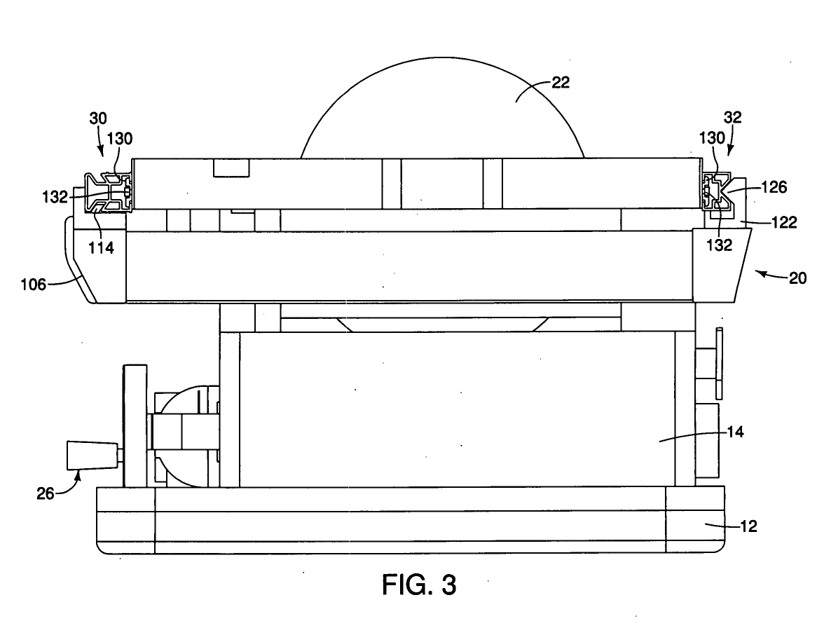

Embodiments of the present invention are shown in the drawings, with a first preferred embodiment being shown in FIGS. 1-6 wherein a power table saw assembly, indicated generally at 10, is illustrated and has a base 12, a frame structure 14, a top indicated generally at 15, which includes a top extension indicated generally at 16 that is slidable relative to the top 15. The top 15 and top extension 16 have top surfaces 18a and 18b, respectively. The saw assembly also includes a rip fence, indicated generally at 20 and a blade 22. The saw 10 is a portable table saw that has a bevel and blade height adjust mechanism, indicated generally at 26.

These general components are typical of such portable table saws that can be easily transported to a jobsite where they can be used in conjunction with construction, remodeling and similar projects. While it is important that they be relatively lightweight so that a craftsman can carry them from their vehicles to the location where they will be used on a jobsite without difficulty, it is also important that they be designed and constructed so that they can withstand the inevitable wear and tear that they are subjected to at a construction or similar jobsite.

It is also highly desirable, if not essential, that such saws 10 have a rip fence 20 so that accurate cuts can be made. Because the surface area of the top surfaces 18a and 18b is generally not as large as is often present with larger table saws that are used at a work shop, it is important that the rip fence 20 can be removed, so that the saws are capable of cutting relatively large sheets of plywood and the like. The rip fence 20 should also be capable of being easily and conveniently transported with the saw without being separated from it. It is also desirable to store the fence 20 somewhere on the saw 10 when it has been removed for the purpose of cutting plywood or the like.

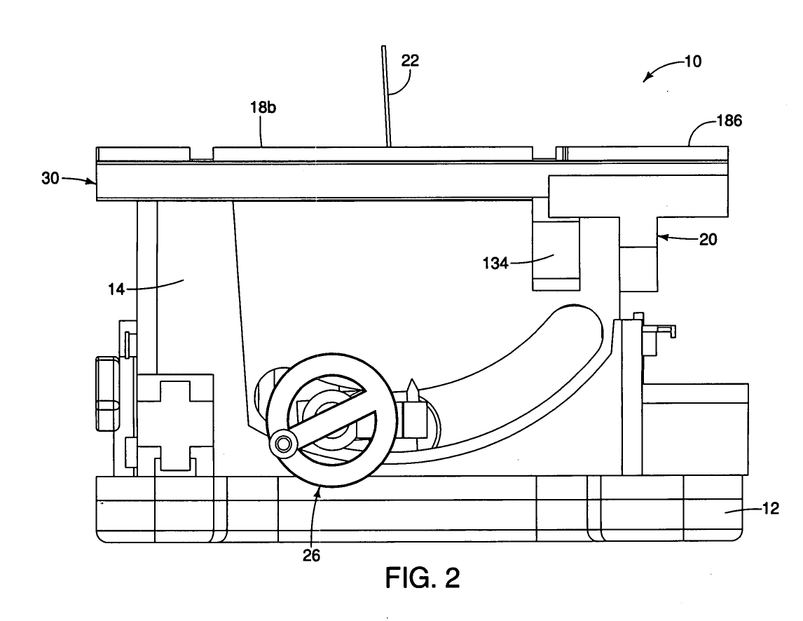

Embodiments of the present invention have the desirable result of being able to store the fence 20 underneath the table top in a manner whereby the very same structure to which the fence attaches during use is employed to store the fence when it is not being used. In this regard, and referring to FIGS. 1 and 6, the fence is mounted on the table top in its upright operating position where the fence is located above the surfaces 18a and 18b of the table top 15 and top extension 16. The fence is shown in its stored “upside down” position where the top of the fence is directed downwardly in FIGS. 2, 3 and 4.

More particularly, the fence is attached to a front rail, indicated generally at 30, as well as a rear rail, indicated generally at 32. The rails 30 and 32 are preferably metal extrusions that are configured to interact with locking mechanisms of the fence 20 so that they can be locked in the upright operating position as well as upside down to the same rails in the stored position. The rails are preferably made of aluminum which is strong and lightweight which lessens the weight of the saw and still enables the fence 20 to be locked in either its operating or stored positions. As shown in FIG. 1, the rails 30 and 32 preferably extend along the front and rear vertical surfaces of the table top 15 and top extension 16 to thereby enable the rip fence to be removed and placed on either side of the blade 22. As will be also explained in detail, the rails 30 and 32 may be mounted in a manner whereby they are securely attached to the top extension 16 so that the rails as well as the top extension are slidable relative to the tabletop 15 so that when the extension 16 is moved to its extended or separated position, the range of the fence is extended well beyond the right edge of the table top 15. This greatly contributes to the use of a fence to cut larger work pieces such as plywood sheets or the like.

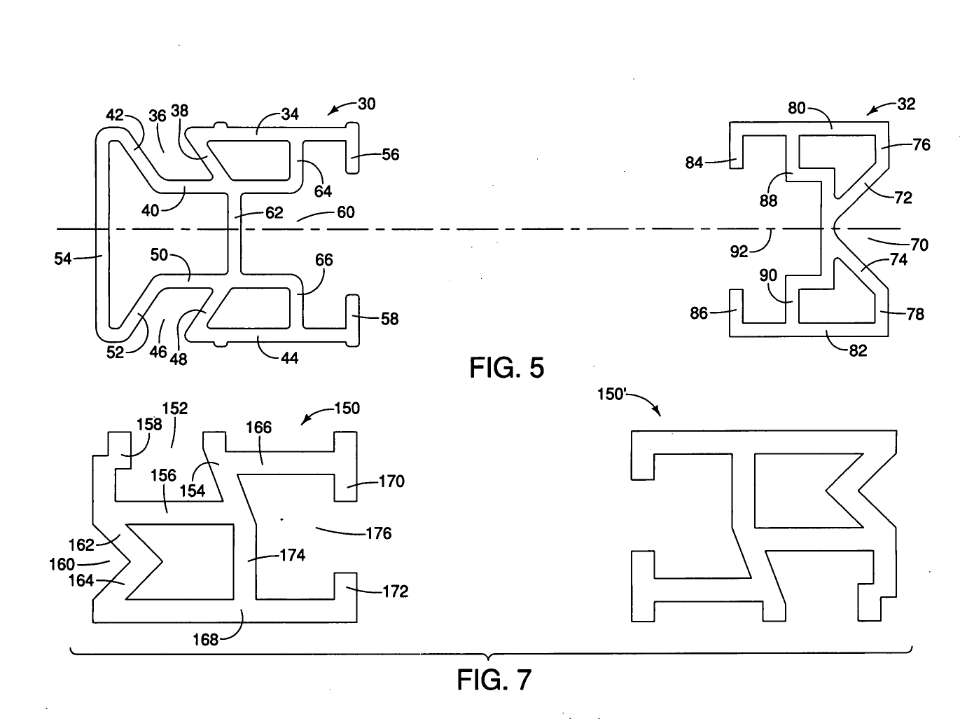

The configuration of the front rail 30 best shown in the enlarged drawing of FIG. 5 and has a top wall 34 in which a recess 36 is located, with the recess being defined by an angled front wall 38, a bottom wall 40, and a rear wall 42, with the front and rear walls 38 and 42 being inclined at an angle that is preferably the same and is approximately 40° relative to vertical, but can be any acute angle compatible with receiving and retaining the locking mechanism of the fence 20. A bottom wall 44 has a similar recess 46 with front, bottom and rear walls 48, 50 and 52 that are symmetrical with the recess 36 and the walls 38, 40 and 42 in the top surface 34. The rear walls 42 and 52 merge with a connecting wall 54. The top and bottom walls 44 and 34 have respective inwardly extending wall portions 56 and 58, respectively, which define a mounting portion with a large recess 60. An interior structural wall 62 merges with right angled wall portions 64 and 66 that extend to the respective top and bottom walls 34 and 44.

With regard to the rear rail 32, also best shown in FIG. 5, it has a generally V-shaped recess 70 defined by walls 72 and 74 which merge with outer end wall portions 76 and 78 that in turn merge with a top wall 80 and bottom wall 82. These two walls also have inwardly directed front wall portions 84 and 86 which together with angled central wall portions 88 and 90 form a mounting portion recess 92 that is very similar to the configuration of the mounting portion of the front rail 30.

From the description of both of the front and rear rails 30 and 32, and noting how they are installed on the tabletop 15 and extension 16 as shown in FIG. 1, it should be appreciated that the top walls 34 and 80, respectively, are more exposed to being struck by objects or work pieces and the like and are more susceptible to being damaged through use. The symmetrical configuration is such that the rails can be removed from the tabletop and reversed so that the bottom walls become the top walls after being mounted again and can thereby lengthen their useful life in certain circumstances.

Turning now to the fence 20, it is shown in detail in FIG. 6 and has a construction that is similar to that shown in U.S. Pat. No. 6,360,641, assigned to the same assignee as the present invention, which is specifically incorporated by reference herein.

The fence 20 has a front clamping mechanism, indicating generally at 100, and a rear clamping mechanism, indicated generally at 102, which engage opposite ends of the fence 20 to the front and rear rails 30 and 32. The front and rear clamping mechanisms 100 and 102 interact with one another by virtue of a rod 104 that extends between them. The fence 20 includes a handle 106 that is rotatable about a pivot 108 that is anchored in a front casting 109. The handle is in turn connected to a link 110 which is connected to a cam member 112. A locking tab 114 is also attached to the casting 109 by a screw 115. The locking tab 114 extends downwardly and is configured to engage the recess 36 of the front rail 30 when the fence is placed on the rail 30 and the handle lowered into locking engagement, as shown. The cam 112 engages an activation plate 116 that pivots around pivot point 118, the upper end of which engages the rod 104. When the handle is in the position shown in FIG. 6, the fence 20 is locked in both the front end and the back end and securely holds the fence to both of the rails. When the handle 106 is rotated upwardly, i.e., clockwise about the pivot 108, the cam will be rotated in a clockwise manner around its pivot 120 which results in the rear clamping mechanism 102 being released. This enables the handle end portion of the fence to be lifted and the locking tab 114 being drawn out of the recess 36 of the front rail 30.

With regard to the rear clamping mechanism, an adjustment screw 122 is screwed into a threaded hole in the upper end of a rear activating plate 122 and contacts the left end portion of the rod 104. The rear activating plate 122 is rotatable around pivot 124 and has a triangular tab 126 at its lower portion which engages the recess 70 of the rear rail 32. Thus, when the handle 106 is in its locked or clamping position, the triangular tab 126 fully engages the rear rail and the locking tab 114 engages the recess 36 in the front rail 30.

The fence has a block 128 with an aperture 136 through which the left end of the rod 104 passes to contact the screw 120. A spring 132 has one end that bears against the block 128 and its opposite end against an annular washer that is attached to the rod so that the spring biases the rod toward the right and moves the rod in that direction when the handle 106 is lifted to disengage the locking mechanism. Another spring (not shown) may be provided to rotate the activating plate 122 in the clockwise direction to disengage the locking mechanism 102 when the handle 106 is lifted.

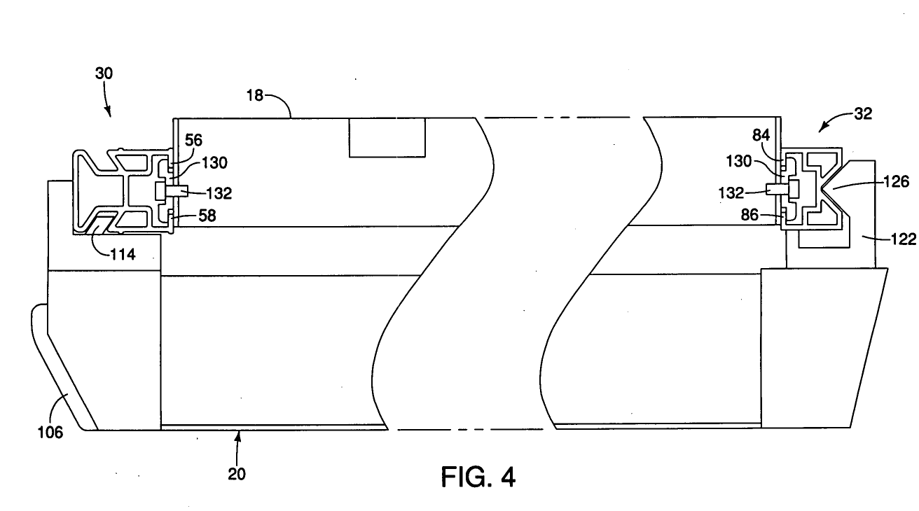

As previously mentioned, the rails 30 and 32 may be mounted in a manner whereby they and extension 16 can slide relative to the front and rear surfaces of the table top 15 and in this regard, and referring to FIG. 4, such a mounting configuration is shown to include a mounting plate 130 that has a base portion having a width that is slightly less than the distance between the inside surfaces of the top and bottom walls 34 and 44 for the front rail 30 and the inside surfaces of the top and bottom walls 80 and 82 of the rear rail 32. The base portion of the mounting plate 130 abuts the front or rear vertical surfaces of the table top 15 and the extension 16. The mounting plate 130 has wider top and bottom portions that engage the inside surfaces of the wall portions 56 and 58 of the front rail 30 and wall portions 85 and 86 of the rear rail 32. At least two screws 132 are used to attach the mounting plate 130 to each of the front and rear walls of the table top extension 16 so securely attach the rails to the extension 16. While not shown, it may be desirable to place slider plates or a spacer mounting plate instead of the plates 130 on the front and rear walls of the main table 15 to enable sliding movement of the rails 30 and 32 relative to the main table top 15. It is also desirable to have a locking lever 134 which controls a locking mechanism which is not shown, but is known to those of ordinary skill in the art. The locking lever 134 can lock the extension 16 at any position in which it is placed. It should be understood that other mounting mechanisms can be used to accomplish such desirable sliding without introducing unwanted movement that could interfere with the accuracy and effectiveness of the use of the fence on the saw.

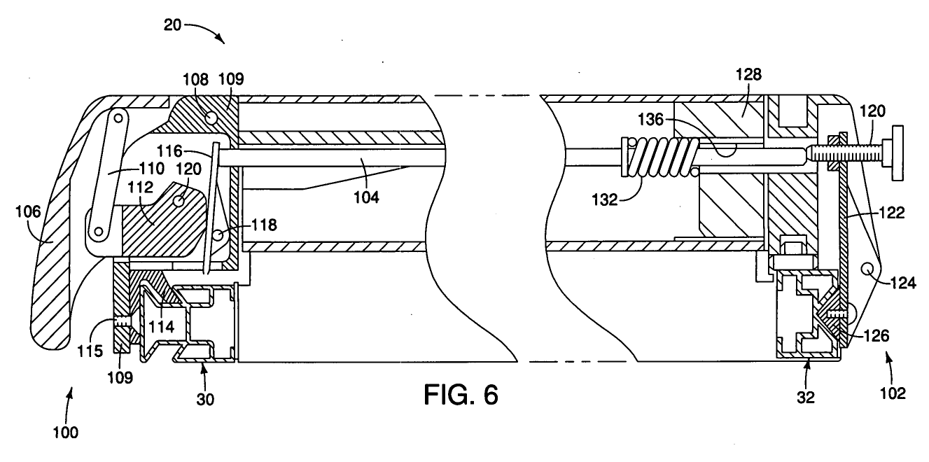

An alternative embodiment is shown in FIG. 7 where a front rail is indicated generally at 150 and the rear rail 150′. The front rail has an upper recess 152 that is formed by a front wall 154, bottom wall 156 and a rear wall 158 which is also the outer end wall of the extrusion. The front wall includes a V-shaped recess 160 which is formed by angled walls 162 and 164. The opposite end portion has a top wall portion 166 and a bottom wall portion 168, with inwardly directed end portions 170 and 172 which together with a structural wall 174 define a mounting recess 176 that is similar to the mounting portion 60 and 92 of the front and rear rails 30 and 32, respectively. An advantage of this embodiment is that it can be simply turned upside down and be mounted to the rear edge of the table as is shown in FIG. 7. This enables a single extrusion to be used for both the front and rear rails. While the fence 20 may require some modification, it should be understood that if the fence 20 were to be modified to operate with the alternative embodiment in the upright position, it could be turned upside down, have its ends reversed (whereby the handle portion would be placed on the rear end of the saw) and be attached in its upside down position.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. A power table saw assembly comprising:
a base assembly configured to retain a motor assembly for driving a rotatable blade;
a table top assembly having a top surface with a opening through which a rotating blade can extend;
an elongated front rail extending across the front of said table top assembly for providing a mounting structure for a fence extending generally parallel to the plane of the rotating blade;
an elongated rear rail extending across the rear of said table top assembly for providing a mounting structure for said fence extending generally parallel to the plane of the rotatable blade;
a fence having a clamping handle configured to be selectively moved between clamping and releasing positions, thereby enabling said fence to be adjustably mounted to said front and rear rails for selectively positioning the same at different operating locations relative to said blade, said fence being removable from said front and rear rails when said clamping handle is released;
said front and rear rails being configured to retain said fence in said operating locations and to also clamp said fence in a stored location wherein said fence is located underneath said table top surface.

2. A power table saw assembly as defined in claim 1 wherein said front rail comprises an elongated metal structure having generally planar top and bottom surfaces and defining a mounting portion configured for attachment to said table top assembly and a fence retaining portion adjacent said mounting portion, said fence retaining portion having a retaining recess on each of its upper and lower surfaces for retaining said fence so that it can extend either upwardly or downwardly.

3. A power table saw assembly as defined in claim 2 wherein said rear rail comprises an elongated metal structure having a mounting portion on an inner end configured for attachment to said table top assembly and a fence retaining portion adjacent said mounting portion, said fence retaining portion having a retaining recess on an outer end surface.

4. A power table saw assembly as defined in claim 1 wherein said front and rear rails comprises an elongated metal structure having a mounting portion on an inner end configured for attachment to said table top assembly and a fence retaining portion adjacent said mounting portion, said fence retaining portion having a retaining recess on an outer end surface adjacent a first wall and a retaining recess in a second wall opposite said first wall.

5. A power table saw assembly as defined in claim 1 wherein said front and rear rails are metal extrusions.

6. A power table saw assembly as defined in claim 5 wherein said metal extrusions are aluminum.

7. A power table saw assembly as defined in claim 2 wherein each of said retaining recesses comprises a volume defined by a front recess wall that extends from its associated top or bottom surface and merges with a bottom recess wall that is generally parallel with said planar top and bottom surfaces, with said bottom recess wall merging with a rear recess wall that extends to said associated top or bottom surface, said front recess wall being configured at a predetermined acute angle relative to said bottom recess wall.

8. A power table saw assembly as defined in claim 7 wherein said predetermined acute angle is within the range of about 40° to about 60°.

9. A power table saw assembly as defined in claim 3 wherein said mounting portion comprises a volume generally defined by said top and bottom surfaces and a generally planar end wall having an elongated slot therein, with end wall portions located on opposite sides of said slot.

10. A power table saw assembly as defined in claim 9 wherein said table top assembly has front and rear surfaces generally transverse to said top surface configured to provide mounting surfaces for mounting said respective rails thereto, said power table saw assembly further comprising at least one mounting bracket configured to contact said end wall portions on opposite sides of said slot and an attachment device for securing said bracket to said transverse surfaces.

11. A power table saw assembly as defined in claim 10 wherein said attachment device comprises one or more screws or bolts or the like.

12. A power table saw assembly as defined in claim 10 wherein said mounting bracket has a center portion that is slightly smaller than the width of said slot and wider top and bottom portions that engage the inside surface of said end wall portions.

13. A power table saw assembly as defined in claim 12 wherein said mounting bracket for each of said front and rear rails is elongated and extends a substantial length along said rails.

14. A power table saw assembly as defined in claim 13 wherein said power table top assembly extends outwardly beyond said base assembly on at least one side of the said table saw assembly to provide space for storing said fence underneath said table top assembly.

15. A power table saw assembly as defined in claim 14 wherein said table top assembly has a main table portion and an extension table portion, said mounting brackets fixedly attaching said extension table portion to said front and rear rails and said front and rear rails being slidably attached to said main table portion, thereby enabling said extension table portion to slide said rails relative said mounting brackets and separate said extension table portion from said main table portion.

16. A power table saw assembly as defined in claim 3 wherein said rear rail retaining recess has a generally V shaped configuration.

17. A power table saw assembly as defined in claim 16 wherein said fence clamping handle comprises a tongue that is inserted into one of said front rail retaining portion retaining recesses when said the handle end of said fence is installed on said front rail.

18. A power table saw assembly comprising:
a base assembly configured to retain a motor assembly for driving a rotatable blade;
a table top assembly having a top surface with a opening through which a rotating blade can extend, front and rear edge portions generally perpendicular to said top surface, said table top assembly extending outwardly beyond said base assembly on at least one side thereof;
a front rail extending across and operatively connected to said front edge of said table top assembly;
a rear rail extending across and operatively connected to said rear edge of said table top assembly;
a fence having a clamping handle configured to be selectively moved between clamping and releasing positions, thereby enabling said fence to be adjustably mounted to said front and rear rails for selectively positioning the same at different operating locations relative to said blade, said fence being removable from said front and rear rails when said clamping handle is released;
said front and rear rails being configured to retain said fence in said operating locations and to also clamp said fence in a stored location wherein said fence is underneath said table top surface.

19. A power table saw assembly as defined in claim 18 further comprising mounting brackets for mounting said front and rear rails in sliding engagement with said table top portion, said table top assembly has a main table portion and an extension table portion, said mounting brackets being attached to said main table portion and not attached to said extension table portion, said front and rear rails being attached to said extension table portion, thereby enabling said extension table portion to slide said rails relative said mounting brackets and separate said extension table portion from said main table portion.

20. A power table saw assembly as defined in claim 19 wherein said front rail comprises an elongated metal structure having generally planar top and bottom surfaces and defining a mounting portion configured for attachment to said table top assembly and a fence retaining portion adjacent said mounting portion, said fence retaining portion being symmetrically configured to have a retaining recess on each of its upper and lower surfaces for retaining said fence so that it can extend either upwardly or downwardly.

21. A power table saw assembly as defined in claim 20 wherein said rear rail comprises an elongated metal structure having a mounting portion on an inner end configured for attachment to said table top assembly and a fence retaining portion adjacent said mounting portion, said fence retaining portion having a retaining recess on an outer end surface.
